(19) United States
(12) Patent Application Publication
(10) Pub. No.: US 2009/0327810 A1
(43) Pub. Date: Dec. 31, 2009

(54) SYSTEM FOR EXAMINING EFFECTS AND PROPOSING CONSEQUENTIAL ACTIONS

(75) Inventors: Timothy Moorhouse, Bournemouth (GB); Paul Roberts, Christchurch (GB); Julian Alldridge, Christchurch (GB); Roland Green, Colehill (GB)

Correspondence Address: Fleit Gibbons Gutman Bongini & Bianco PL, 21355 EAST DIXIE HIGHWAY, SUITE 115, MIAMI, FL, 33180, US

(73) Assignee: SELEX COMMUNICATIONS LIMITED, Essex (GB)

(21) Appl. No.: 12/307,887

(22) PCT Filed: Jul. 10, 2007
(86) PCT No.: PCT/GB07/50392

§ 371 Date: Jan. 7, 2009

(30) Foreign Application Priority Data
Jul. 11, 2006 (GB) 0613661.8

(51) Int. Cl. G06N 5/00; G06F 11/28

(52) U.S. Cl. 714/26; 706/54; 714/E11.178

(57) ABSTRACT

Traditionally, in fault diagnosis systems, the user is instructed to investigate symptoms exhaustively until a single fault is identified. A more advanced known system recognises that it may be cost effective to address a fault that has been determined as being likely but not certain to exist; in preference to further examination of the symptoms. However this technique has been found not to work well when a symptom is known to be only sometimes associated with a fault. The invention addresses this problem by 1) deriving a first value, for each fault, of probable benefit of acting on that fault and for identifying the fault for which that value is greatest, 2) deriving a second value, for each symptom, of probable benefit of an investigation into that symptom and for identifying the symptom for which that second value is greatest, and 3) comparing the greatest first value with the greatest second value thereby determining when to switch from investigating symptoms to acting upon a fault. By employing the invention the aforementioned problem can be overcome because the system calculates the extent to which each symptom examination would improve the situation, assuming no further symptom investigations are used.

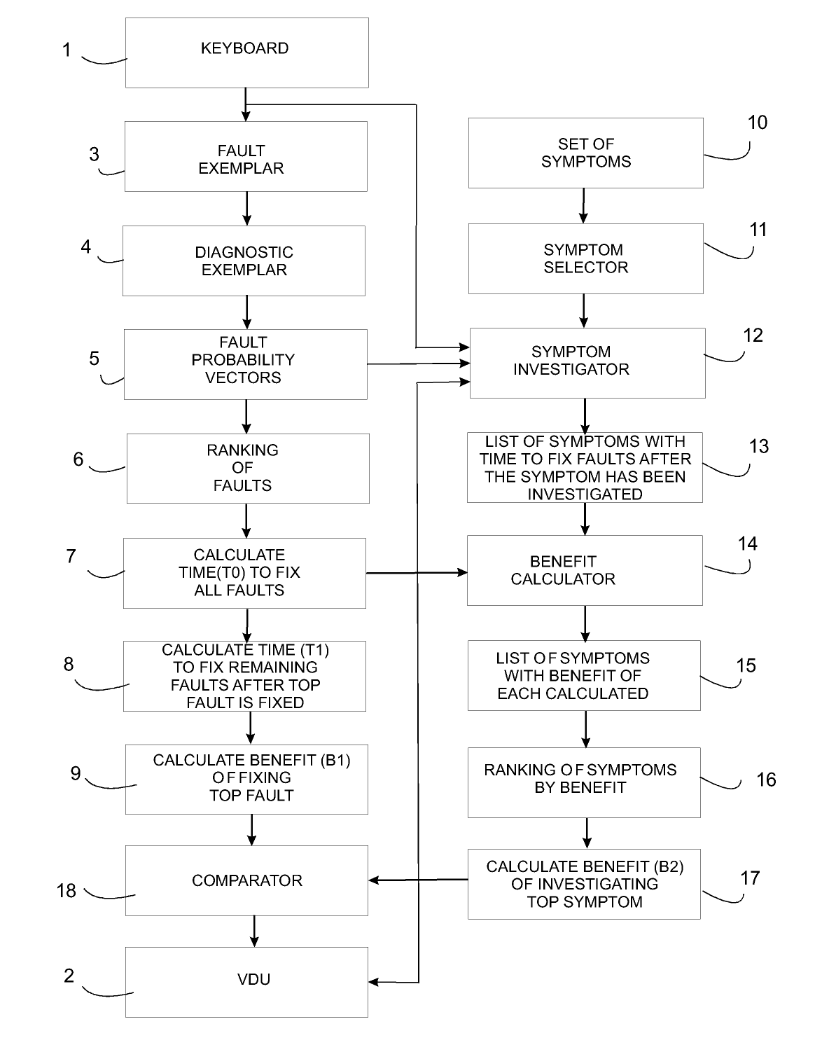

This invention relates to a system for examining effects and then proposing or taking consequential actions to modify causes of those effects. The invention is of special value in fault diagnosis equipment (i.e. where the aforementioned “cause” is a fault). However, the invention has the potential to be used in many other environments where conditions other than faults need to be controlled, modified or eliminated.

Traditionally, in fault diagnosis systems, the user is instructed to investigate symptoms exhaustively until a single fault is identified. For example, a diagnosis system for faulty motor vehicles would typically ask the user to perform a series of tests and inspections culminating in the unambiguous identification of a fault, whereupon the user is told to fix that fault.

A more sophisticated system is described in our patent specification WO2004/010646 the content of which is imported into this specification by reference. That system makes a step forward by recognising that it may be cost effective to address a fault that has been determined as being likely but not certain to exist; in preference to further examination of the symptoms. It may be more cost effective, in terms of optimising the route to identification of all faults existing on the system, to address a potential fault rather than investigate a symptom, even though the fault is not certain to exist.

When we refer to “cost” in this specification it is to be understood that this cost may be an expression of cost in any terms appropriate to the circumstances. For example the cost of replacing a motor vehicle engine might be a financial value equal to the price of obtaining a new engine and the cost of employing labour to remove the faulty engine and to fit the new engine. In other circumstances the financial cost may not be as important as, say, the cost in terms of time taken to perform the diagnosis and to fix a fault; so the cost may be measured in terms of time or a combination of time and financial cost. In another example, “cost” could be a measure of, or at least be partially dependant on, inconvenience or risk.

The system of WO2004/010646, whilst highly effective in most situations, was found not to work well when a symptom is known to be only sometimes associated with a fault. The inventors recognised the reason for this to be that the effect of symptom investigations was being overestimated.

According to the invention there is provided a system for establishing a procedure for taking consequential actions on causes of those effects comprising:
a. means for identifying a set of potential causes, effects, and known relationships between the causes and the effects,
b. means for deriving a first value, for each cause, of probable benefit of acting on that cause and for identifying the cause for which that value is greatest,
c. means for deriving a second value, for each effect, of probable benefit of an investigation into that effect and for identifying the effect for which that second value is greatest, and
d. means for comparing the greatest first value with the greatest second value thereby determining when to switch from investigating effects to acting upon causes.

By employing the invention the aforementioned problem can be overcome because the system calculates the extent to which each symptom (or other effect) examination would improve the situation, assuming no further symptom investigations are used.

The aforementioned problem associated with the known system of WO2004/010646 arose when the “means for defining relationships” specified, for some of the identified effects, that the effect is possibly but not certainly associated with a cause. The known system WO2004/010646 underestimated the effectiveness of some symptom investigations. The invention is therefore of particular benefit in such situations because it allows that problem to be overcome.

The system preferably includes means for assigning a rank to each identified cause. This is preferably designed to calculate the rank as a function that is directly dependant on the probability of the relevant “cause” existing and inversely dependant on a measure of cost (as previously defined) to carry out an action on the cause e.g. fixing a fault. This strategy has the effect of increasing the tendency of the system to make or suggest fixes that, whilst having a lower probability of curing a particular isolated fault as compared with known strategies, are likely to result in a quicker or more cost-effective fix of a complex system because they can be performed quickly.

One example of how the invention may be used will now be described by way of example with reference to the accompanying single drawing of a fault diagnosis system constructed in accordance with the invention.

The illustrated system takes the form of a portable computer having user interfaces in the form of a keyboard 1 and a VDU 2. The computer is programmed to perform functions as illustrated by blocks 3 to 18. Many of the processes performed are in themselves known and can be derived by reference to WO2004/010646. The following description therefore is directed mainly to novel features employed in the present invention.

During a set-up stage of the system, raw diagnostic information is loaded from keyboard 1, or possibly from a removeable data storage device (not shown), into a storage area 3 to define a “fault exemplar” exactly as described in WO2004/010646. This is also called the “action exemplar”. This is a two dimensional matrix of symptoms and faults. Each column of the matrix represents a potential fault that is known to possibly occur in the system to be tested; and each row represents a symptom.

Each cell of the fault exemplar contains one of three values:

| | |
|---|---|
| 1 | representing the fact that the fault always causes the symptom |
| 0 | representing that the fault never causes the symptom and |
| * | indicating that the fault sometimes but not always causes the |
| | symptom. |

Using processes also described in WO2004/010646, the fault exemplar is used first to derive a diagnostic exemplar matrix 4 which contains fractional values between −1 and +1 and then, also as described in WO2004/010646 particularly the paragraph beginning on page 15 line 10, to derive probability vectors containing values that indicate the likelihood of each fault being the cause of the set of currently ascertained symptoms. Probability vectors for these faults are stored in a register 5.

At 6, all of the faults are ranked in descending order of “effectiveness of fix.” This is directly related to the probability of the fault and inversely dependent on the measure of cost. The first fault is therefore the “Top” fault.

A mechanism 7 determines the time T0 to fix all the Faults

$$( = {\sum }_{i = 1}^{n} {C}_{i} {\sum }_{j = i}^{n} {p}_{j} ) .$$

This is the original time against which other times will be measured. The method of calculation gives the pattern by which the times to fix sets of faults are calculated.

At 8, the time T1 to fix the remaining faults, once the top fault has been fixed, is calculated, taking into account the probability that the top fault may or may not have remedied the situation.

Next, at 9, is calculated the benefit B1 of fixing the top fault. B1 is referred to as the “first value” in the accompanying claims. Mathematically, this is calculated from (T0−T1)/Cf. When analysed, it became apparent that this expression is identically equal to unity. (Other faults have lower benefits.) T0−T1 is equivalent to the “Diagnostic Progress” of fixing the top fault. The Diagnostic Progress of an action is the estimated time taken to fix the system of faults before the action is taken, less the time taken to fix the system of faults remaining after the action is taken, taking account of whether the action is successful or not.

A register 10 contains a set of symptom descriptions that have yet to be investigated and takes a form exactly as described in WO2004/010646 on page 23 lines 10 to 21. A selection mechanism 11 passes the symptom descriptions, one by one, to a symptom investigator 12 which has access to the fault probability vectors from 5. On receipt of each symptom from selector 11, the symptom investigator 12 identifies the extent by which investigation of that symptom would be used to reduce the cost in terms of time of fixing the remaining faults after that symptom has been investigated. This is done in the following way.

The diagnostic progress of a symptom investigation is the reduction in cost of the diagnostic process were we to have the information about the symptom investigation. The calculation has to be done assuming each fault in turn is the one present and seeing the diagnostic progress of the symptom investigation.
Let the cost of investigating Fault f be C_{f}.
Let the Action Exemplar row for Symptom s and Fault Fix f be ae_{s, f}. Each term of this can be either 1, 0 or *.
Let there be rows M1, M*, M0, R1 and R0 as representations of the Action Exemplar row for Symptom s.
Let the row M1_{f} be 1 if ae_{s, f} is 1 and 0 otherwise. Let the row M*_{f} be 1 if ae_{s, f} is * and 0 otherwise. Let the row M0_{f} be 1 if ae_{s, f} is 0 and 0 otherwise.
Let the row R1_{f} be the same as ae_{s, f} except that a * is replaced by 1. These denote the fault fixes that remain if the Symptom returns “Set” when investigated. R1_{f}=M1_{f}+M*_{f}.
Let the row R0_{f} be 1−ae_{s, f} except that where ae_{s, f} is a *, then R0_{f} takes the value 1. These denote the fault fixes that remain if the Symptom returns “Clear” when investigated. R0_{f}=M0_{f}+M*_{f}.

The following table gives an example of the various values of the five rows for an exemplary, short Fault set.

| | Fault Fix 1 | Fault Fix 2 | Fault Fix 3 |
|---|---|---|---|
| ae_{s, f} | 1 | * | 0 |
| R1_{f} | 1 | 1 | 0 |
| R0_{f} | 0 | 1 | 1 |
| M1_{f} | 1 | 0 | 0 |
| M*_{f} | 0 | 1 | 0 |
| M0_{f} | 0 | 0 | 1 |

| | Case 0: | Case 1: | Case 2: | Case 3: | Case 4: |
|---|---|---|---|---|---|
| | Cost without | Cost with SI. | Cost with SI. | Cost with SI. | Cost with SI. |
| | Symptom | ae_{s,f} = 1 | ae_{s,f} = * | ae_{s,f} = * | ae_{s,f} = 0 |
| | Investigation | (Symptom is | (Symptom is | (Symptom is | (Symptom is |
| | (SI) | set) | set) | clear) | clear) |
| Weighting | | M1ᵢ | M*ᵢ/2 | M*ᵢ/2 | M0ᵢ |
| If the fault IS | C₁ | C₁ | C₁ | C₁ | C₁ |
| Fault 1 | | | | | |
| If the fault IS | C₁ + C₂ | R1₁*C₁ + C₂ | R1₁*C₁ + C₂ | R0₁*C₁ + C₂ | R0₁*C₁ + C₂ |
| Fault 2 | | | | | |
| If the fault IS | C₁ + C₂ + C₃ | R1₁*C₁ + R1₂* | R1₁*C₁ + R1₂* | R0₁*C₁ + | R0₁*C₁ + |
| Fault 3 | | C₂ + C₃ | C₂ + C₃ | R0₂*C₂ + C₃ | R0₂*C₂ + C₃ |
| If the fault IS | C₁ + C₂ + C₃ + | R1₁*C₁ + | R1₁*C₁ + | R0₁*C₁ + | R0₁*C₁ + |
| Fault 4 | C₄ | R1₂*C₂ + | R1₂*C₂ + | R0₂*C₂ + | R0₂*C₂ + |
| | | R1₃*C₃ + C₄ | R1₃*C₃ + C₄ | R0₃*C₃ + C₄ | R0₃*C₃ + C₄ |
| Etc | | | | | |

The diagnostic progress of investigating a symptom is therefore, “the calculated time to fix all faults” less “the calculated time to fix the faults remaining after the symptom investigation.”

Calculating the diagnostic progress on a “per fault” basis:

$$\begin{matrix}Diagnostic Progress = {C}_{1} \cdot ( {p}_{1} + {p}_{2} + {p}_{3} ) + {C}_{2} \cdot ( {p}_{2} + {p}_{3} ) + {C}_{3} \cdot {p}_{3} - {p}_{1} ( M {1}_{1} \cdot {C}_{1} + \frac{{M}_{1}^{*}}{2} \cdot {C}_{1} + \frac{{M}_{1}^{*}}{2} \cdot {C}_{1} + M {0}_{1} \cdot {C}_{1} ) - {p}_{2} ( ( M {1}_{2} + \frac{{M}_{2}^{*}}{2} ) \cdot ( {C}_{1} \cdot R {1}_{1} + {C}_{2} ) + ( M {0}_{2} + \frac{{M}_{2}^{*}}{2} ) \cdot ( {C}_{1} \cdot R {0}_{1} + {C}_{2} ) ) - {p}_{3} ( \begin{matrix}( M {1}_{3} + \frac{{M}_{3}^{*}}{2} ) \cdot ( {C}_{1} \cdot R {1}_{1} + {C}_{2} \cdot R {1}_{2} + {C}_{3} ) + \\ ( M {0}_{3} + \frac{{M}_{3}^{*}}{2} ) \cdot ( {C}_{1} \cdot R {0}_{1} + {C}_{2} \cdot R {0}_{2} + {C}_{3} )\end{matrix} ) - {p}_{4} ( … ) & \\ Diagnostic Progress = {\sum }_{i = 1}^{n - 1} {C}_{i} {\sum }_{j = i + 1}^{n} {p}_{j} ( \begin{matrix}1 - ( M {1}_{j} + \frac{{M}_{j}^{*}}{2} ) \cdot R {1}_{i} - \\ ( M {0}_{j} + \frac{{M}_{j}^{*}}{2} ) \cdot R {0}_{i}\end{matrix} ) & \end{matrix}$$

The C₁p₁, C₂p₂, C₃p₃, etc terms cancel out, so diagnostic progress becomes:

$$Diagnostic Progress = {\sum }_{i = 1}^{n - 1} {C}_{i} {\sum }_{j = i + 1}^{n} {p}_{j} ( \begin{matrix}1 - ( M {1}_{j} + \frac{{M}_{j}^{*}}{2} ) \cdot R {1}_{i} - \\ ( M {0}_{j} + \frac{{M}_{j}^{*}}{2} ) \cdot R {0}_{i}\end{matrix} )$$

Remembering that M1ᵢ+M*ᵢ+M0ᵢ=1 for all i, and that R1ᵢ=M1ᵢ+M*ᵢ and R0ᵢ=M0ᵢ+M*ᵢ, and writing the initial 1 under the sum as (M1ⱼ+M*ⱼ+M0ⱼ)*(M1ᵢ+M*ᵢ+M0ᵢ), and normalising by C_{S} to provide the benefit of diagnostic progress relative to cost, this can be written:

$$Benefit = \frac{{\sum }_{i = 1}^{n - 1} {C}_{i} {\sum }_{j = i + 1}^{n} {p}_{j} ( \begin{matrix}M {1}_{j} M {0}_{i} + M {0}_{j} \cdot M {1}_{i} + \frac{{M}_{j}^{*}}{2} \cdot \\ ( M {1}_{i} + M {0}_{i} )\end{matrix} )}{{C}_{s}}$$

The output of the symptom investigator 12 is used at 13 to compile a list of symptoms with the time to fix the reduced set of faults after the symptom has been investigated. This is equivalent to the operation performed at 7 with the reduced fault set should the symptom be set, and also performing it with the fault set should the symptom be clear. The two results are summed together and the sum is weighted by the probability that the symptom is set or clear. Let this total sum be TS1. Thus, the mechanism 13 is able to produce a list of symptoms with a time to fix the remaining faults for each one.

A benefit calculating mechanism 14 calculates the benefit of the symptom investigation. This is (T0−TS1)/C_{S}. The Diagnostic Progress of the symptom is (T0−TS1). The benefit of the symptom is directly dependant on the Diagnostic Progress of performing the symptom investigation, and inversely dependent on the cost of investigating the symptom. The actual formula used, is the one labelled “Benefit” above, where the effect of the subtraction has been manipulated by algebraic means to ensure that it produces a sum of positive numbers, rather than a difference of larger numbers. Such a difference would lead to potential difficulties when implementing the algorithm on a computer with a floating-point unit.

The mechanism indicated at 15 uses the output of 14 to produce a list of symptoms with benefits attached to each.

At 16, the symptoms are ranked in descending order of benefit. This reveals the top symptom. The benefit B2 for the top symptom is held in register 17. B2 is referred to as the “second value” in the accompanying claims.

A comparator 18 compares the benefit value B2 held at 17 with B1 held at 9. If B2 is less than B1, then a symptom investigation is more effective than a fault fix at reducing the remaining time to fix the failed system. If B1 is less than B2, then the fault fix is more effective.

The investigation is used to generate messages that are displayed on the VDU 2 suggesting that the user should make symptom investigations likely to give the greatest benefit in helping to reduce the number of possible faults. The results of these investigations are entered at 1 by the user and this information is fed back to the symptom investigator 12 to produce a reduced set of fault probability vectors as compared with those stored at 5. In an alternative system, the symptom investigations would be performed automatically by calling upon available sensors and built-in test equipment.

When the benefit value is greater than or equal to 1, the symptom investigation at 12 is continued. When it becomes less than 1, a message is displayed on the VDU 2 recommending that the user start fixing the faults in the order as ranked at 6 in preference to continued investigation of symptoms.

Whilst the illustrated system is designed to recommend symptom investigations to be performed by a human operator and to produce a list of faults ranked in an order to be fixed also by a human operator, it will be appreciated that in more sophisticated systems either or both of these operations could be performed automatically.

1. A system for establishing a procedure for examining effects and then taking consequential actions on causes of those effects comprising:
(a) means for identifying a set of potential causes, effects, and known relationships between the causes and the effects,
(b) means for deriving a first value, for each cause, of probable benefit of acting on that cause and for identifying the cause for which that value is greatest,
(c) means for deriving a second value, for each effect, of probable benefit of an investigation into that effect and for identifying the effect for which that second value is greatest, and
(d) means for comparing the greatest first value with the greatest second value thereby determining when to switch from investigating effects to acting upon causes.

2. A system according to claim 1 comprising means for establishing an order or rank of causes to be acted on.

3. A system according to claim 2 in which the means for establishing an order or rank is designed to assigning a rank value to each identified cause such that the rank value is directly dependant on the probability of that cause existing and inversely dependant on a measure of cost (as herein defined) of taking action on that cause.

4. A system according to claim 1 comprising means for establishing an order or rank of effects according to the benefit of investigating each of them.

5. A system according to claim 4 in which the means for defining relationships contains data for some identified effects that are known to be possibly but not certainly associated with a cause.

6. A system according to claim 5 in which the causes are faults in a system and the effects are symptoms of those faults.

7. A system according to claim 2 comprising means for establishing an order or rank of effects according to the benefit of investigating each of them.

8. A system according to claim 7 in which the means for defining relationships contains data for some identified effects that are known to be possibly but not certainly associated with a cause.

9. A system according to claim 8 in which the causes are faults in a system and the effects are symptoms of those faults.

10. A system according to claim 3 comprising means for establishing an order or rank of effects according to the benefit of investigating each of them.

11. A system according to claim 10 in which the means for defining relationships contains data for some identified effects that are known to be possibly but not certainly associated with a cause.

12. A system according to claim 11 in which the causes are faults in a system and the effects are symptoms of those faults.

13. A system according to claim 1 in which the means for defining relationships contains data for some identified effects that are known to be possibly but not certainly associated with a cause.

14. A system according to claim 13 in which the causes are faults in a system and the effects are symptoms of those faults.

15. A system according to claim 2 in which the means for defining relationships contains data for some identified effects that are known to be possibly but not certainly associated with a cause.

16. A system according to claim 15 in which the causes are faults in a system and the effects are symptoms of those faults.

17. A system according to claim 3 in which the means for defining relationships contains data for some identified effects that are known to be possibly but not certainly associated with a cause.

18. A system according to claim 17 in which the causes are faults in a system and the effects are symptoms of those faults.

19. A system according to claim 1 in which the causes are faults in a system and the effects are symptoms of those faults.

20. A system according to claim 2 in which the causes are faults in a system and the effects are symptoms of those faults.

21. A system according to claim 3 in which the causes are faults in a system and the effects are symptoms of those faults.

22. A system according to claim 4 in which the causes are faults in a system and the effects are symptoms of those faults.
